(19) United States
(12) Patent Application Publication
(10) Pub. No.: US 2025/0076039 A1
(43) Pub. Date: Mar. 6, 2025

(54) RANGING TELESCOPE

(71) Applicants: Sintai Optical (Shenzhen) Co., Ltd., ShenZhen City (CN); Asia Optical Co., Inc., Taichung (TW)

(72) Inventors: Yao Pei, ShenZhen City (CN); Fang-Li Ma, ShenZhen City (CN); Yue-Ye Chen, ShenZhen City (CN); Hua-Tang Liu, Taichung (TW)

(21) Appl. No.: 18/810,774

(22) Filed: Aug. 21, 2024

(30) Foreign Application Priority Data
Aug. 31, 2023 (CN) 202311130013.6

(51) Int. Cl. G01C 3/04; G02B 5/00; G02B 23/04; G02B 27/02

(52) U.S. Cl. CPC G01C 3/04; G02B 5/005; G02B 23/04; G02B 27/026

(57) ABSTRACT

A ranging telescope includes an object lens unit, an image turning module, an eyepiece unit and a display. Ambient light passes through the object lens unit, the image turning module and the eyepiece unit to form an ambient light path. The display is configured to generate display light which passes through the image turning module and then through the eyepiece unit. The light flux regulator is disposed in the ambient light path and between the object lens unit and the eyepiece unit, for regulating flux of the ambient light or the display light that passes through the eyepiece unit, so as to regulate an intensity difference between the ambient light and the display light passing through the eyepiece unit.

### BACKGROUND OF THE INVENTION

### Field of the Invention

The invention relates to a ranging telescope.

### Description of the Related Art

In the actual use of ranging telescopes, it is often encountered that the brightness in the field of view is too high, resulting in the display (OLED) characters (text and/or symbols) being unclear, which greatly affects the performance of the ranging telescope. At present, the most commonly used method to solve this problem are to increase the brightness of the display characters or to reduce the brightness in the field of view. However, this method inevitably brings new troubles.

Increasing the brightness of the display characters will not only cause the problem of increased energy consumption, but reduce the life span of the display. It will also greatly increase the probability of display burn-in. Besides, there is a limit to increment of the brightness of the display characters. The increment cannot be infinite. Therefore, the improvement of viewing by this method is limited.

Reducing the brightness within the field of view is an effective method to improve character recognition on the display. By coating a film with specific optical properties on the surface of the objective lens or prisms, the red light transmittance of the display characters can be increased and the background light transmittance can be also reduced, thereby improving the relative brightness of the display characters (the above-mentioned red light is only an example and not a limitation). By using this method, however, the telescope may have bluish background color and color distortion. Further, when observation is performed under low light intensity conditions, it is likely that the display characters is too bright thereby blocking the field of view. Therefore, this method cannot meet both of the brightness requirement of display characters in high light intensities and the brightness requirement of display characters in low light intensities.

### BRIEF SUMMARY OF THE INVENTION

To address the issues above, the invention provides a ranging telescope in which the relative brightness of the display characters can be maintained in a proper range facilitating the user to recognize the display characters, regardless of whether the ambient light is strong or weak. The ranging telescope in accordance with an exemplary embodiment of the invention includes an object lens unit, an image turning module, an eyepiece unit and a display. Ambient light passes through the object lens unit, the image turning module and the eyepiece unit to form an ambient light path. The display is configured to generate display light which passes through the image turning module and then through the eyepiece unit. The light flux regulator is disposed in the ambient light path and between the object lens unit and the eyepiece unit, for regulating flux of the ambient light or the display light that passes through the eyepiece unit, so as to regulate an intensity difference between the ambient light and the display light passing through the eyepiece unit.

In another exemplary embodiment, the ranging telescope further includes an optical sensor electrically connected to the light flux regulator for sensing an intensity of the ambient light, thereby controlling the light flux regulator to regulate the flux of the ambient light or the display light.

In yet another exemplary embodiment, the image turning module is a prism module.

In another exemplary embodiment, the image turning module includes a plurality of lenses.

In yet another exemplary embodiment, the image turning module has a light incident side, a light emitting side and an interior, and the light flux regulator is a variable aperture disposed at the light incident side, the light emitting side or the interior of the image turning module.

In another exemplary embodiment, the variable aperture has a variable diameter that is reduced for reducing the flux of the ambient light through the eyepiece unit when an intensity of the ambient light sensed by the optical sensor is greater than a first predetermined value. The variable diameter of the variable aperture is increased for increasing the flux of the ambient light through the eyepiece unit when the intensity of the ambient light sensed by the optical sensor is smaller than a second predetermined value. The first predetermined value is greater than or equal to the second predetermined value.

In yet another exemplary embodiment, the variable aperture has a maximum aperture diameter and a minimum aperture diameter. A difference between the maximum aperture diameter and the minimum aperture diameter is ranged from 40.2% to 44.4% of the maximum aperture diameter. A difference between the maximum aperture diameter and the minimum aperture diameter is ranged from 69.6% to 76.9% of the minimum aperture diameter.

In another exemplary embodiment, the ranging telescope has a first f-number when the variable aperture is adjusted to have a maximum aperture diameter. The ranging telescope further has a second f-number when the variable aperture is adjusted to have a minimum aperture diameter. The first f-number is ranged from 54.8% to 60.6% of the second f-number.

In yet another exemplary embodiment, the ranging telescope has a first entrance pupil diameter when the variable aperture is adjusted to have a minimum aperture diameter. The ranging telescope further has a second entrance pupil diameter when the variable aperture is adjusted to have a maximum aperture diameter. A ratio of the first entrance pupil diameter to the second entrance pupil diameter is ranged from 0.548 to 0.606. The ranging telescope further has a first exit pupil diameter when the variable aperture is adjusted to have the minimum aperture diameter. The ranging telescope further has a second exit pupil diameter when the variable aperture is adjusted to have the maximum aperture diameter. A ratio of the first exit pupil diameter to the second exit pupil diameter is ranged from 0.548 to 0.606.

In another exemplary embodiment, the image turning module has a light incident side, a light emitting side and an interior, and the light flux regulator is a light transmission display disposed at the light incident side, the light emitting side or the interior of the image turning module.

In yet another exemplary embodiment, the light transmission display has a transmission. The light transmission display is adjusted to reduce the transmission for reducing the flux of the ambient light through the eyepiece unit when an intensity of the ambient light sensed by the optical sensor is greater than a first predetermined value. The light transmission display is adjusted to increase the transmission for increasing the flux of the ambient light through the eyepiece unit when the intensity of the ambient light sensed by the optical sensor is smaller than a second predetermined value. The first predetermined value is greater than or equal to the second predetermined value.

In another exemplary embodiment, variation of the transmission of the light transmission display is ranged from 31% to 85%.

In yet another exemplary embodiment, the light transmission display includes a region, and the transmission of the light transmission display is changed only in the region.

In another exemplary embodiment, the region is away from an optical axis of the ranging telescope.

In yet another exemplary embodiment, the ranging telescope further includes a light emitter configured to emit ranging light, and a light receiver configured to receive the ranging light, wherein the ranging light is emitted by the light emitter, passes through the image turning module and the object lens unit, reaches an target object, is reflected by the target object, passes through the object lens unit, and is received by the light receiver.

In another exemplary embodiment, the ranging telescope further includes a light emitter configured to emit ranging light, and a light receiver configured to receive the ranging light, wherein the ranging light is emitted by the light emitter, passes through the image turning module and the object lens unit, reaches an target object, is reflected by the target object, passes through the object lens unit, and is received by the light receiver.

### BRIEF DESCRIPTION OF THE DRAWINGS

The invention can be more fully understood by reading the subsequent detailed description and examples with references made to the accompanying drawings, wherein:

FIG. 1 is a schematic view showing the structure of the ranging telescope in accordance with a first embodiment of the invention.

FIG. 2 is a schematic view showing the structure of the ranging telescope in accordance with a second embodiment of the invention.

### DETAILED DESCRIPTION OF THE INVENTION

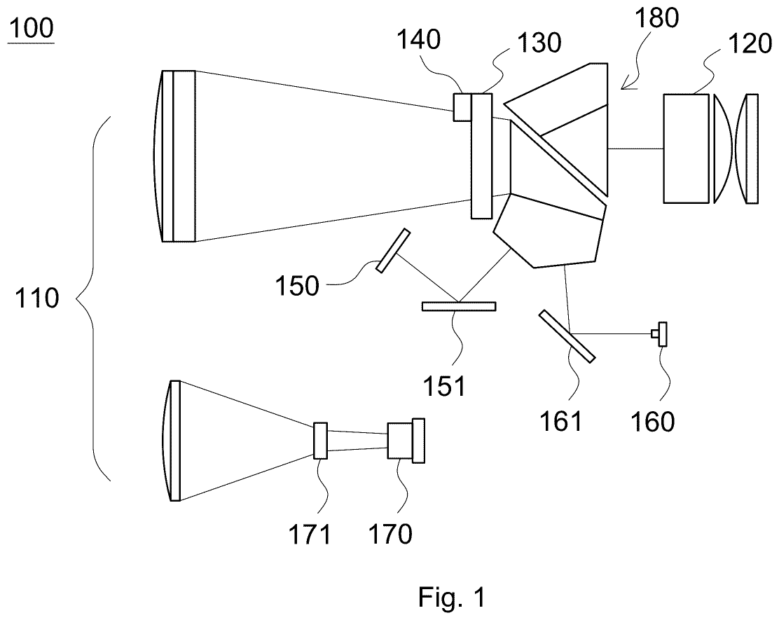

Referring to FIG. 1, a ranging telescope 100 in accordance with a first embodiment of the invention includes an object lens unit, 110, an eyepiece unit 120, a light emitter 160, a light receiver 170, a display 150, an image turning module 180, a light flux regulator 130, an optical sensor 140, a light condenser 171, and a plurality of reflecting mirror 151, 161.

In operation of the ranging telescope 100, ambient light travels through the object lens unit 110, the light flux regulator 130, the image turning module 180 and the eyepiece unit 120 and reaches user's eye, for the user to observe the surroundings. Further, ranging light emitted by the light emitter 160 is reflected by the reflecting mirror 161, passes through the image turning module 180, the light flux regulator 130 and the object lens unit 110, reaches an target object (not shown), is reflected by the target object back to the ranging telescope 100, passes through the object lens unit 110 and the light condenser 171, and reaches the light receiver 170, whereby the distance of the target object can be obtained by calculations according to the difference between when the ranging light is emitted and when the ranging light is received. Further, display light generated by the display 150 is reflected by the reflecting mirror 151, passes through the image turning module 180 and the eyepiece unit 120, and reaches user's eye, thereby providing important information (e.g. the distance of the target object) for user's reference. The information can be shown by characters that include letters, numbers, operations, punctuation marks, and other symbols.

The light emitter 160 may be a laser diode or other light sources. The light receiver 170 may be a photoelectric diode (PD), a photomultiplier tube (PMT), a charge coupled device (CCD), an avalanche photodiode (APD), a single-photon avalanche diode (SPAD) or other sensors, and the optical sensor 140 may be any of the described sensor. The display 150 may be an organic light-emitting diode (OLED), a liquid crystal display (LCD) or other displays.

As described above, not only the ambient light but the display light passes through the image turning module 180 and the eyepiece unit 120 and reaches user's eye. Therefore, the user can see both of the surroundings and the characters of the display 150. In this embodiment, the light flux regulator 130 is a variable aperture disposed between the object lens unit 110 and the image turning module 180 to regulate the light amount that is passed through the eyepiece unit 120 and received by user's eye. The optical sensor 140 is disposed beside the light flux regulator 130 and is electrically connected to the light flux regulator 130 for sensing an intensity of the ambient light and transmitting an intensity signal to a controller (not shown). In operation of the ranging telescope 100, ambient light that is too strong will affect the user's ability to recognize the characters of the display 150. Therefore, if the ambient light sensed by the optical sensor 140 is too strong, then the variable aperture will be adjusted by the controller to reduce the aperture diameter so that the flux of the ambient light through the variable aperture can be reduced. Accordingly, an intensity difference between the ambient light and the display light passing through the eyepiece unit is reduced and the user can clearly see the characters of the display 150. Further, if the ambient light sensed by the optical sensor 140 is too weak, then the variable aperture will be adjusted by the controller to increase the aperture diameter so that the flux of the ambient light through the variable aperture can be increased. Accordingly, an intensity difference between the ambient light and the display light passing through the eyepiece unit is reduced and the scenery within the field of view can become brighter without being affected by the brightness of the characters of the display 150.

Specifically, when an intensity of the ambient light sensed by the optical sensor 140 is greater than a first predetermined value, the variable aperture (i.e. the light flux regulator 130) is adjusted to reduce the aperture diameter so that the flux of the ambient light through eyepiece unit 120 can be reduced and the light amount received by user's eye can be also reduced. However, when an intensity of the ambient light sensed by the optical sensor 140 is smaller than a second predetermined value, the variable aperture (i.e. the light flux regulator 130) is adjusted to increase the aperture diameter so that the flux of the ambient light through eyepiece unit 120 can be increased and the light amount received by user's eye can be also increased. The first predetermined value is greater than or equal to the second predetermined value. The variable aperture has a maximum aperture diameter and a minimum aperture diameter. A difference between the maximum aperture diameter and the minimum aperture diameter is ranged from 40.2% to 44.4% of the maximum aperture diameter, and a difference between the maximum aperture diameter and the minimum aperture diameter is ranged from 69.6% to 76.9% of the minimum aperture diameter. In this embodiment, when an intensity of the ambient light sensed by the optical sensor 140 is greater than 20,000 lux, the variable aperture is adjusted to reduce the aperture diameter so as to reduce the flux of the ambient light through eyepiece unit 120 and the light amount received by user's eye. Further, when an intensity of the ambient light sensed by the optical sensor 140 is smaller than 1,000 lux, the variable aperture is adjusted to increase the aperture diameter so as to increase the flux of the ambient light through eyepiece unit 120 and the light amount received by user's eye. In this embodiment, the maximum aperture diameter of the variable aperture is 6.34 mm, while the minimum aperture diameter of the variable aperture is 3.66 mm.

In the invention, the variable aperture can be designed to be further adjusted manually. That is, the variable aperture can be adjusted manually to change the aperture diameter when the user considers that the ambient light is too strong or too weak.

It is worth noting that the ranging telescope 100 is a fixed-focus telescope (i.e. the focal length is fixed) that is taken as the first embodiment for describing the invention. When the aperture diameter of the variable aperture changes, the f-number, vignetting, entrance pupil diameter and exit pupil diameter correspondingly change, and the field of view (FOV) remains unchanged. In this embodiment, a first f-number is ranged from 54.8% to 60.6% of a second f-number where the first f-number corresponds to the maximum aperture diameter of the variable aperture and the second f-number corresponds to the minimum aperture diameter of the variable aperture. As described above, the focal length and the field of view of the ranging telescope 100 are unchanged while the entrance pupil diameter and the exit pupil diameter are changeable. In this embodiment, a ratio of a first entrance pupil diameter (or a first exit pupil diameter) to a second entrance pupil diameter (or a second exit pupil diameter) is ranged from 0.548 to 0.606 where the first entrance pupil diameter (or the first exit pupil diameter) corresponds to the minimum aperture diameter of the variable aperture and the second entrance pupil diameter (or the second exit pupil diameter) corresponds to the maximum aperture diameter of the variable aperture.

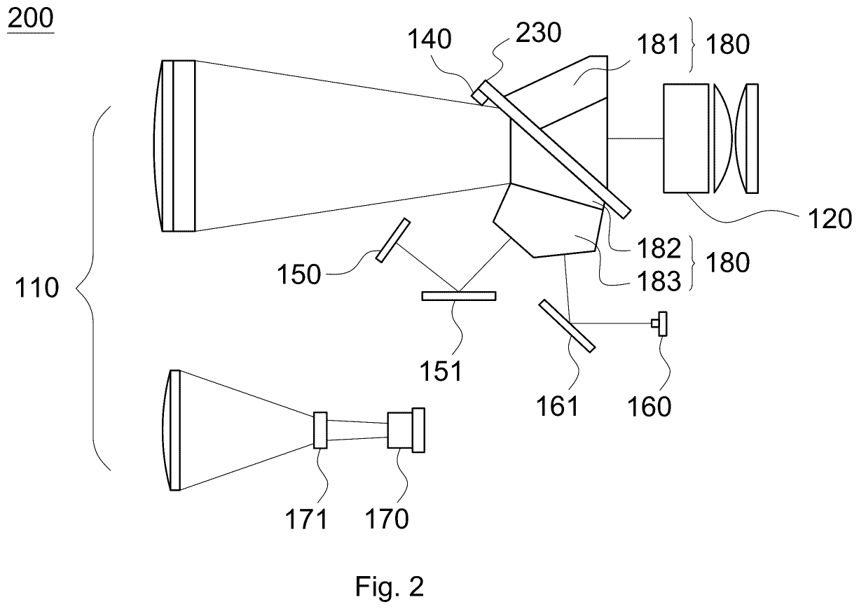

Referring to FIG. 2, a ranging telescope 200 in accordance with a second embodiment of the invention includes an object lens unit, 110, an eyepiece unit 120, a light emitter 160, a light receiver 170, a display 150, an image turning module 180, a light flux regulator 230, an optical sensor 140, a light condenser 171, and a plurality of reflecting mirror 151, 161. The elements of the second embodiment same as those of the first embodiment are indicated by the same symbols and the descriptions thereof are omitted.

In the second embodiment, the image turning module 180 includes a plurality of prisms 181, 182, 183, and the light flux regulator 230 is a light transmission display disposed between the prism 181 and the prism 182. The transmission of the light transmission display is adjustable to regulate the light amount that is passed through the eyepiece unit 120 and received by user's eye. The optical sensor 140 is disposed beside the light flux regulator 230 to sense an intensity of the ambient light. If the ambient light sensed by the optical sensor 140 is too strong, then the transmission of the light transmission display will be reduced so that the flux of the ambient light through the light transmission display can be reduced. Accordingly, an intensity difference between the ambient light and the display light passing through the eyepiece unit is reduced and the user can clearly see the characters of the display 150. Further, if the ambient light sensed by the optical sensor 140 is too weak, then the transmission of the light transmission display will be increased so that the flux of the ambient light through the light transmission display can be increased. Accordingly, an intensity difference between the ambient light and the display light passing through the eyepiece unit is reduced and the scenery within the field of view can become brighter without being affected by the brightness of the characters of the display 150.

Specifically, when an intensity of the ambient light sensed by the optical sensor 140 is greater than a first predetermined value, the light transmission display (i.e. the light flux regulator 230) is adjusted to reduce the transmission so that the flux of the ambient light through eyepiece unit 120 can be reduced and the light amount received by user's eye can be also reduced. When an intensity of the ambient light sensed by the optical sensor 140 is smaller than a second predetermined value, the light transmission display (i.e. the light flux regulator 230) is adjusted to increase the transmission so that the flux of the ambient light through eyepiece unit 120 can be increased and the light amount received by user's eye can be also increased. The first predetermined value is greater than or equal to the second predetermined value. In the second embodiment, when an intensity of the ambient light sensed by the optical sensor 140 is greater than 20,000 lux, the light transmission display is adjusted to reduce the transmission so as to reduce the flux of the ambient light through eyepiece unit 120 and the light amount received by user's eye. Further, when an intensity of the ambient light sensed by the optical sensor 140 is smaller than 1,000 lux, the light transmission display is adjusted to increase the transmission so as to increase the flux of the ambient light through eyepiece unit 120 and the light amount received by user's eye. In this embodiment, the variation of transmission of the light transmission display is ranged from 31% to 85%.

Similarly, in the invention, the light transmission display can be designed to be further adjusted manually. That is, the light transmission display can be adjusted manually to change the transmission when the user considers that the ambient light is too strong or too weak.

Ambient light travels to user's eye along an ambient light path, while display light travels to user's eye along a display light path. The ambient light path and the display light path meet in the image turning module 180 where the light flux regulator 230 is disposed. By such arrangement, the light flux regulator 230 can be configured to regulate the flux of the ambient light and/or the flux of the display light.

A third embodiment is substantially same as the second embodiment except that the light transmission display (i.e. the light flux regulator 230) of the third embodiment has a region, and the transmission of the light transmission display is changed only in the region (not the entire light transmission display). As described above, both the ambient light and the display light pass through the image turning module 180 and the eyepiece unit 120 and reach user's eye so that the user can see both of the surroundings and the characters of the display 150. Characters are only shown in a region in the view field. Therefore, adjustment of the transmission of the entire light transmission display is not necessary. Instead, the light transmission display has a region and only the region requires the transmission to be adjusted (a location in the field of view corresponding to the region is the location of the display characters in the field of view). If the ambient light is too strong or too weak, then the transmission of the region of the light transmission display will be adjusted so that the user can clearly recognize the characters as well as see the surroundings. In the third embodiment, the region of the light transmission display where the transmission is adjustable is distant from the optical axis of the light transmission display. In other words, when the ambient light is too bright, the transmission of the outer region of the light transmission display is smaller than that of the central-axis (optical-axis) region of the light transmission display.

In the first embodiment, the light flux regulator 130 is disposed at the light incident side of the image turning module 180. In the second embodiment and the third embodiment, the light flux regulator 230 is disposed in the image turning module 180. However, the invention is not limited thereto. In the first embodiment, the light flux regulator 130 can be changed to be disposed in the image turning module 180. In the second embodiment and the third embodiment, the light flux regulator 230 can be changed to be disposed at the light incident side of the image turning module 180. In some other embodiments, the light flux regulator can be disposed at the light emitting side of the image turning module to regulate the light amount through the eyepiece unit.

In the first, second, and third embodiments, the image turning module 180 is a prism module. However, the invention is not limited thereto. The image turning module 180 may include a plurality of lenses for changing the travel paths of the ambient light and the display light so that the ambient light and the display light can pass through the eyepiece unit and reach user's eye.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A ranging telescope, comprising:
an object lens unit;
an image turning module;
an eyepiece unit wherein ambient light passes through the object lens unit, the image turning module and the eyepiece unit to form an ambient light path;
a display configured to generate display light which passes through the image turning module and then through the eyepiece unit;
a light flux regulator disposed in the ambient light path and between the object lens unit and the eyepiece unit, for regulating flux of the ambient light or the display light that passes through the eyepiece unit, so as to regulate an intensity difference between the ambient light and the display light passing through the eyepiece unit.

2. The ranging telescope as claimed in claim 1, further comprising an optical sensor electrically connected to the light flux regulator for sensing an intensity of the ambient light, thereby controlling the light flux regulator to regulate the flux of the ambient light or the display light.

3. The ranging telescope as claimed in claim 1, wherein the image turning module is a prism module.

4. The ranging telescope as claimed in claim 1, wherein the image turning module comprises a plurality of lenses.

5. The ranging telescope as claimed in claim 1, wherein the image turning module has a light incident side, a light emitting side and an interior, and the light flux regulator is a variable aperture disposed at the light incident side, the light emitting side or the interior of the image turning module.

6. The ranging telescope as claimed in claim 5, wherein:
the variable aperture has a variable diameter that is reduced for reducing the flux of the ambient light through the eyepiece unit when an intensity of the ambient light sensed by the optical sensor is greater than a first predetermined value;
the variable diameter of the variable aperture is increased for increasing the flux of the ambient light through the eyepiece unit when the intensity of the ambient light sensed by the optical sensor is smaller than a second predetermined value;
the first predetermined value is greater than or equal to the second predetermined value.

7. The ranging telescope as claimed in claim 5, wherein:
the variable aperture has a maximum aperture diameter and a minimum aperture diameter;
a difference between the maximum aperture diameter and the minimum aperture diameter is ranged from 40.2% to 44.4% of the maximum aperture diameter;
a difference between the maximum aperture diameter and the minimum aperture diameter is ranged from 69.6% to 76.9% of the minimum aperture diameter.

8. The ranging telescope as claimed in claim 5, wherein:
the ranging telescope has a first f-number when the variable aperture is adjusted to have a maximum aperture diameter;
the ranging telescope further has a second f-number when the variable aperture is adjusted to have a minimum aperture diameter;
the first f-number is ranged from 54.8% to 60.6% of the second f-number.

9. The ranging telescope as claimed in claim 5, wherein:
the ranging telescope has a first entrance pupil diameter when the variable aperture is adjusted to have a minimum aperture diameter;
the ranging telescope further has a second entrance pupil diameter when the variable aperture is adjusted to have a maximum aperture diameter;
a ratio of the first entrance pupil diameter to the second entrance pupil diameter is ranged from 0.548 to 0.606;
the ranging telescope further has a first exit pupil diameter when the variable aperture is adjusted to have the minimum aperture diameter;
the ranging telescope further has a second exit pupil diameter when the variable aperture is adjusted to have the maximum aperture diameter;
a ratio of the first exit pupil diameter to the second exit pupil diameter is ranged from 0.548 to 0.606.

10. The ranging telescope as claimed in claim 1, wherein the image turning module has a light incident side, a light emitting side and an interior, and the light flux regulator is a light transmission display disposed at the light incident side, the light emitting side or the interior of the image turning module.

11. The ranging telescope as claimed in claim 10, wherein:
the light transmission display has a transmission;
the light transmission display is adjusted to reduce the transmission for reducing the flux of the ambient light through the eyepiece unit when an intensity of the ambient light sensed by the optical sensor is greater than a first predetermined value;
the light transmission display is adjusted to increase the transmission for increasing the flux of the ambient light through the eyepiece unit when the intensity of the ambient light sensed by the optical sensor is smaller than a second predetermined value;
the first predetermined value is greater than or equal to the second predetermined value.

12. The ranging telescope as claimed in claim 11, wherein variation of the transmission of the light transmission display is ranged from 31% to 85%.

13. The ranging telescope as claimed in claim 12, wherein the light transmission display comprises a region, and the transmission of the light transmission display is changed only in the region.

14. The ranging telescope as claimed in claim 13, wherein the region is away from an optical axis of the ranging telescope.

15. The ranging telescope as claimed in claim 1, further comprising:
a light emitter configured to emit ranging light;
a light receiver configured to receive the ranging light;
wherein the ranging light is emitted by the light emitter, passes through the image turning module and the object lens unit, reaches an target object, is reflected by the target object, passes through the object lens unit, and is received by the light receiver.

16. The ranging telescope as claimed in claim 2, further comprising:
a light emitter configured to emit ranging light;
a light receiver configured to receive the ranging light;
wherein the ranging light is emitted by the light emitter, passes through the image turning module and the object lens unit, reaches an target object, is reflected by the target object, passes through the object lens unit, and is received by the light receiver.
